(19) United States
(12) Patent Application Publication
(10) Pub. No.: US 2016/0063025 A1
(43) Pub. Date: Mar. 3, 2016

(54) RAPID SYNC METHOD FOR CLOUD FILE SYSTEM AND CLOUD FILE SYSTEM USING THE SAME

(71) Applicant: ASD Technologies Inc., Seoul (KR)

(72) Inventor: Sun Ung LEE, Seoul (KR)

(21) Appl. No.: 14/521,297

(22) Filed: Oct. 22, 2014

(30) Foreign Application Priority Data
Aug. 29, 2014 (KR) 10-2014-0114091

(51) Int. Cl. G06F 17/30

(52) U.S. Cl. CPC G06F 17/30174; G06F 17/30578; G06F 17/30377; G06F 17/30212

(57) ABSTRACT

Disclosed is a synchronization method of a cloud file system that enables a portable terminal to not consume excessive amount of battery power for data synchronization with the portable terminal such as a smart phone, enables a portable terminal and a stationary user terminal such as a personal computer to upload and download data in an appropriate time, and prevents time delay caused by the excessive traffic, during the data synchronization. To this end, the present disclosure provides a second terminal with data information associated with data when the data is uploaded from a first terminal, and requests and uploads a check message for determining whether the data is the latest data, terminates a data synchronization operation when it is determined that the data is not the latest data based on the check message of the second terminal, and transmits the data to the second terminal so as to request execution of a synchronization operation on the data when it is determined that the data is the latest data based on the check message of the second terminal.

### CROSS-REFERENCE TO RELATED APPLICATION(S)

This application claims the benefit under 35 U.S.C. §119(a) of Korean patent application filed on Aug. 29, 2014 and assigned Serial number 10-2014-0114091, the entire disclosure of which is hereby incorporated by reference.

### TECHNICAL FIELD

The present disclosure relates generally to a rapid synchronization method of a cloud data system and a cloud data system using the same, and more particularly, to a rapid synchronization method of a cloud data system that entrusts a part of a data synchronization process to a client during the data synchronization between a cloud-based data system and the client, so as to minimize network traffic caused by the data synchronization process between a server end and a client end, and to improve a processing speed of the synchronization operation, and a cloud data system using the same.

### BACKGROUND

A cloud data system that expands a storage space by interoperating with a user terminal, such as a personal computer and a smart phone, and a web storage, has been provided, in addition to a Universal Serial Bus (USB) storage medium and an external hard disk drive. The cloud data system stores, in the web storage, data that is stored in a user terminal, and the web storage periodically executes data synchronization with the user terminal so that the web storage includes data identical to the data stored in the user terminal.

FIG. 1 illustrates a conceptual diagram illustrating a data synchronization method of a cloud data system.

Referring to FIG. 1, a recent cloud data system 30 inquires whether the data stored in the cloud data system 30 and the data stored in the client 21 and 22 are identical based on a predetermined period (for example, a few seconds to dozens of minutes) based on a polling scheme, for the synchronization of uploaded data, when data is uploaded from the user terminals 21 and 22 belong to an identical account. When the stored data between the cloud data system 30 and the client 21 and 22 are not identical as a result of the inquiry, it is determined which of the data stored in the cloud data system 30 and the corresponding data of the client 21 and 22 is the latest data, and the data stored in the cloud data system 30 or the client 21 and 22 is updated with the latest data for synchronization.

Subsequently, the cloud data system 30 repeats a synchronization process routine based on a predetermined period (for example, a few seconds to dozens of minutes) so as to synchronize the data stored in the client 21 and 22 with the data stored in the cloud data system 30. As illustrated in FIG. 1, between the cloud data system 30 and the client 21 and 22, a process of continuously comparing data with each other based on a polling scheme at predetermined intervals, and receiving a comparison result, is repeated n times.

A large number of times of synchronization are executed even between the single cloud data system 30 and the single client 22 and network traffic for synchronization may be generated. Accordingly, when a large number of clients 21 and 22 access the cloud data system 30, the network traffic caused by the cloud data system 30 may be rapidly increased.

The network traffic may generate drawbacks in the following perspectives.

1) Due to the excessive traffic, the cloud data system 30 may delay or fail the synchronization process that synchronizes data with the client 21 and 22.

2) Due to the excessive traffic, the cloud data system 30 may fail to provide or share data with the client 21 and 22, in an appropriate time.

3) In a portable terminal that has insufficient electric power (for example, a smart phone and a Personal Media player (PMP)), as compared to a personal computer that uses commercial electricity, an amount of battery power consumed may increase as a synchronization operation with the cloud data system 30 is periodically executed in response to a synchronization request of the cloud data system 30, and thus, the excessive traffic may significantly decrease a power-on-hours of the portable terminal.

A plurality of applications associated with the cloud data system have been filed and data synchronization methods have been publicized.

According to the publication number 10-2002-0033275, a synchronization push service method and system is provided, in which a server transmits a push message to a local terminal every time an event is generated, a client exchanges registered data information between the server and the client in response to the push message so as to determine the chronological order of the data, and the data of the client or the server is updated with the latest data based on the determined order for synchronization of data between the local terminal and the server.

According to the publication number 10-2012-0073799, filed by SK Telecom Co., Ltd, a cloud storage based-data synchronization and service providing device is provided, in which a client provides a server with shared area information included in a shared folder managed by the client, and the server synchronizes the data of the server with the shared folder when the data included in a shared area is changed. However, the publication number 10-2012-0073799 uses a polling scheme that periodically checks data for synchronization, as specified in claim 3 of the corresponding specification, which discloses that the server synchronizes data between the storage space of the server and the shared folder of the client at predetermined intervals.

According to the publication number 10-2014-0031451 (applicant: Samsung Electronics), filed by Samsung Electronics, a synchronization method of a cloud service system is provided in which a client transmits a synchronization request signal to a server, so as to execute data synchronization with the server.

However, the publication number 10-2014-0031451 is the same as others in that the server and the client are required to periodically communicate over a network for data synchronization, and fails to overcome the problems 1) through 3) since the process is repeated that mutually requests a synchronization based on a predetermined period for data synchronization between the server and the client, compares data, and updates previous data with the latest data based on a comparison result.

### SUMMARY

Aspects of the present disclosure are to address at least the above-mentioned problems and/or disadvantages and are to provide at least the advantages described below.

An aspect of the present disclosure is to provide a rapid synchronization method of a cloud data system, and a cloud data system using the same, which does not cause excessive network communication in a mobile-based portable terminal and minimizes network traffic generated by a cloud data system, so that a service provided by the cloud data system is readily and promptly provided to all users without errors.

In accordance with an aspect of the present disclosure, a synchronizing method of a cloud data system that is connected, over a network, to a first terminal and a second terminal, which correspond to an identical account, is provided. The method includes: providing the second terminal with data information associated with data when the data is uploaded from the first terminal, and requesting and obtaining a check message for determining whether the data is the latest data; terminating a data synchronization operation when it is determined that the data is not the latest data based on the check message of the second terminal; and transmitting the data to the second terminal so as to request execution of a synchronization operation on the data when the data is the latest data.

In accordance with another aspect of the present disclosure, a cloud data system that is connected, over a network, to a first terminal and a second terminal, which correspond to an identical account is provided. The cloud data system includes: a server tree DataBase (DB) configured to store stored data information associated with stored data of a data DB; a check message processing module configured to determine, when the data is uploaded from the first terminal, an equality based on the stored data information and data information associated with data, and configured to transmit, when the equality is determined, the data information to the second terminal and to request a check message for determining whether the data is the latest data; and a synchronization module configured to terminate a data synchronization operation when it is determined that the data is not the latest data based on the check message, and to proceed with a synchronization operation on the data with respect to the first terminal and the second terminal only when it is determined that the data is the latest data.

According to the present disclosure, a data synchronization operation is executed only when data is uploaded by a client and thus, may not generate unnecessary network traffic unlike the existing data sync scheme depending on a polling scheme. Accordingly, a cloud data system according to the present disclosure enables a portable terminal to not consume excessive amount of battery power for data synchronization with the portable terminal such as a smart phone, enables a portable terminal and a stationary user terminal such as a personal computer to upload and download data in an appropriate time, and prevents time delay caused by the excessive traffic, during the data synchronization.

### BRIEF DESCRIPTION OF THE DRAWINGS

The above and other objects, features and advantages of the present disclosure will be more apparent from the following detailed description in conjunction with the accompanying drawings, in which:

FIG. 1 illustrates a conceptual diagram of a data synchronization method of a cloud data system;

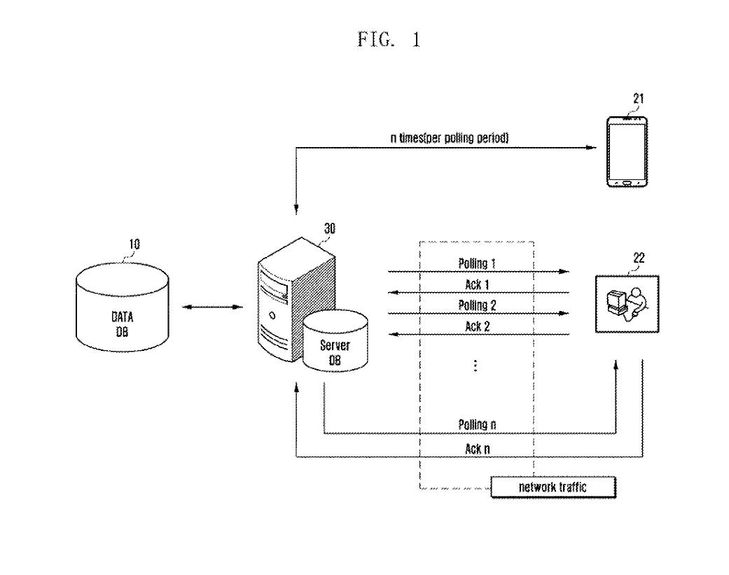

FIG. 2 is a conceptual diagram of a cloud data system according to an embodiment of the present disclosure;

FIG. 3 is a conceptual diagram of a check routine between a cloud data system and a user terminal according to an embodiment of the present disclosure;

FIG. 4 is a conceptual diagram of a state of a cloud data system after comparison of uploaded data according to an embodiment of the present disclosure; and

FIG. 5 is a flowchart of a synchronization method of a cloud data system according to an embodiment of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the present disclosure, data may indicate a file or a folder. In the present disclosure, data may include a media file associated with voice or an image, a document file, a system file, and various types of data that may be installed or stored in computers or portable terminals. However, this may not be limited thereto.

An user terminal according to the present disclosure may be a device including a communication function. For example, the user terminal may be one or a combination of a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, an electronic bracelet, an electronic necklace, an electronic appcessory, a camera, a wearable device, an electronic clock, a wrist watch, a home appliance (for example, refrigerator, air conditioner, cleaner, an artificial intelligence robot, a television (TV), a Digital Versatile Disk (DVD) player, an audio player, oven, microwave oven, washing machine, air cleaner, and electronic picture frames), various types of medical devices (for example, Magnetic Resonance Angiography (MRA), Magnetic Resonance Imaging (MRI), Computed Tomography (CT), scanner, an ultrasonic device, and the like), a navigation device, a Global Positioning System (GPS) receiver, an Event Data Recorder (EDR), a Flight Data Recorder (FDR), a set-top box, a TV box (for example, Samsung HomeSync™, Apple TV™, or Google TV™), an electronic dictionary, a vehicle infotainment device, electronic equipment for a ship (for example, a navigation device for ship, a gyro compass, and the like), avionics, a security device, electronic clothes, an electronic key, a camcorder, game consoles, a Head-Mounted Display (HMD), a flat panel display device, an electronic frame, an electronic album, furniture or a part of buildings/structures having a communication function, an electronic board, an electronic signature receiving device, a wearable device, and a projector. It is obvious to those skilled in the art that the user terminal according to the present disclosure is not limited to the aforementioned devices.

Hereinafter, the present disclosure will be described in detail with reference to the accompanying drawings.

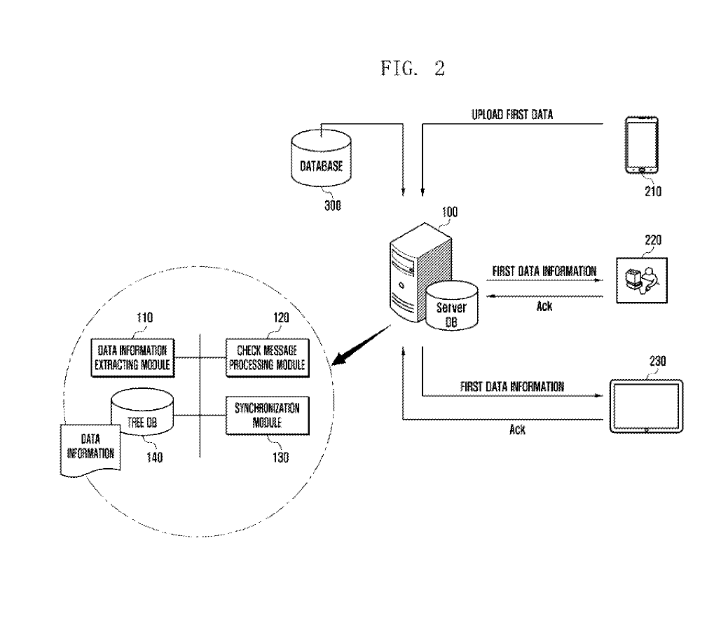

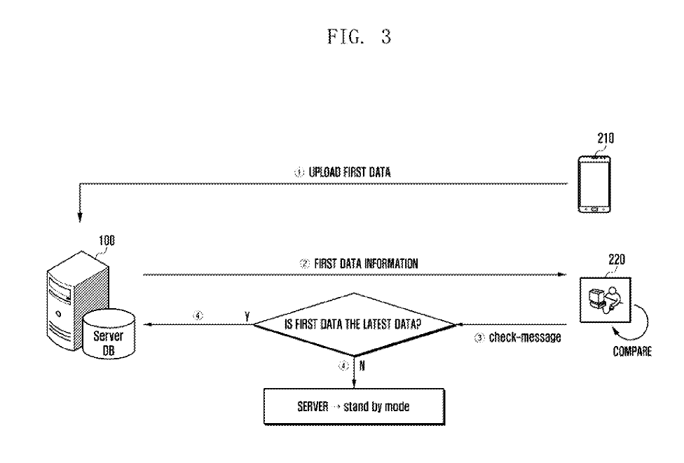

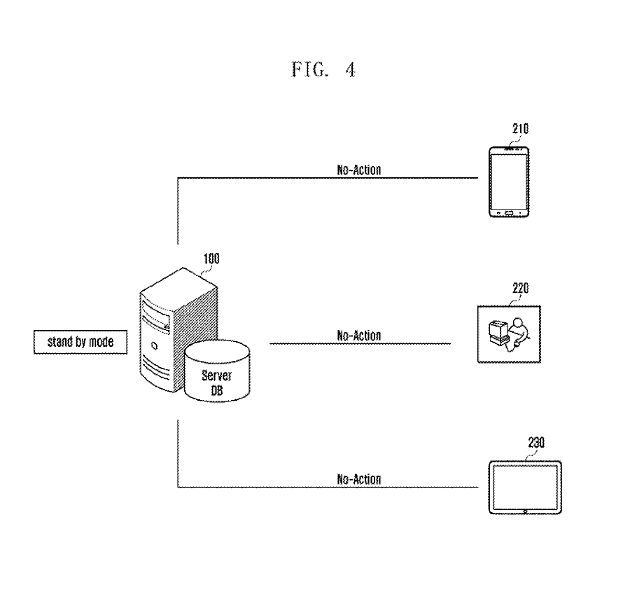

FIG. 2 is a conceptual diagram of a cloud data system according to an embodiment of the present disclosure, FIG. 3 is a conceptual diagram of a check routine between a cloud data system and a user terminal according to an embodiment of the present disclosure, and FIG. 4 is a conceptual diagram of a state of a cloud data system after comparison of uploaded data according to an embodiment of the present disclosure.

Referring to FIGS. 2 through 4, a cloud data system 100 according to an embodiment of the present disclosure includes a server database that is wirelessly or wiredly connected to a database 300 over a network, is wirelessly or wiredly connected to a user terminal 210 through 230 over a network, and stores data information associated with data stored in the database 300.

The database 300 stores data of which uploading is requested by the user terminal 210 through 230. An embodiment of the present disclosure exemplifies that the cloud data system 100 is configured separately from the database 300, the cloud data system 100 may be configured to be integrated with the database 300 or may be configured independently from the database 300.

When data uploading is requested by the user terminal 210, the cloud data system 100 determines whether identical data exists among data stored in the database 300 based on a data title and a data size of data uploaded from the user terminal 210.

When data having an identical title and having an identical size or a size within the margin of error (1% through 5%) exists, the cloud data system 100 recognizes both data as identical data, and determines which of the data stored in the database 300 and the data uploaded from the user terminal 210 is the latest data.

Every data includes time information associated with a time when the data is generated, modified, and changed. Roughly, the time information included in the data may be time information associated with a time when the data is initially generated, and time information associated with a time when the data is modified. The cloud data system 100 may determine which of the data uploaded from the user terminal 210 and the data stored in the database 300 is the latest data, based on the data generation time or the data modification time.

In this instance, the cloud data system 100 according to an embodiment of the present disclosure may execute the comparison of the data information of data uploaded from the user terminal 210 with data information stored in a server tree Database (DB) 140, and may not call the data stored in the database 300 for the comparison. In a case in which the cloud data system 100 requests and obtains data from the database 300, and extracts data information, there may be a concern about traffic occurring between the cloud data system 100 and the database 300.

Accordingly, the cloud data system 100 according to an embodiment of the present disclosure may promptly determine an equality using the data information included in the server tree DB 140.

When it is determined that the data are identical, the cloud data system 100 compares time information between the data (hereinafter, referred to as “first data”) uploaded from the user terminal 210 and the data (hereinafter, referred to as “second data”) which is identical to the first data and is stored in the database 300, so as to determine which of the data is the latest data.

As described above, the time information is one of the generation time and modification time of the first data and the second data. When the second data is the latest data as compared to the first data, the first data uploaded from the user terminal 210 is regarded as data uploaded earlier, as opposed to the latest data. Accordingly, the cloud data system 100 does not execute any synchronization operation on the first data uploaded from the user terminal 210.

A conventional data synchronization method corresponding to the above method compares data with data of a client side based on a predetermined period, even with the identical data. However, when it is determined that the first data uploaded from the user terminal 210 is not the latest data as compared to the second data stored in the database 300, the cloud data system 100 according to an embodiment of the present disclosure may not execute data synchronization with respect to the corresponding file, which is helpful for the cloud data system 100 to generate little network traffic as compared to the conventional data synchronization method.

When it is determined that the first data and the second data are identical, and the first data is the latest data as compared to the second data, the cloud data system 100 provides data information associated with the first data to the user terminal 220 and the user terminal 230. What the cloud data system 100 transfers to the user terminals 220 and 230 is not the data itself but data information associated with the data, that is, time information and size information of the first data. It should be construed that the data itself is not transferred. The cloud data system 100 provides the user terminals 220 and 230 with only the data information. The user terminals 220 and 230 compare internal data (hereinafter, referred to as “third data”) which is determined to be identical to the first data and the data information associated with the first data, using data information of an embedded local DB, and transmits a check message associated with a comparison result to the cloud data system 100. Here, the check message includes information associated with a data title, a data size, and the comparison result.

That is, real data is not exchanged between the cloud data system 100 and the user terminals 220 and 230, but only “data information” associated with the first data through the third data is exchanged, which has a small size so that it is advantageous for transmission.

Here, the local DB indicates an aggregation of data information that the user terminals 220 and 230 have in association with the data stored in the user terminals 220 and 230. The local DB indicates an aggregation or a storage area of information such as a generation time, a modification time, and size information of the data stored in each of the user terminals 220 and 230.

Here, the local DB has fundamentally the same role of a server tree DB that is operated by the cloud data system 100 according to an embodiment of the present disclosure.

The cloud data system 100 may process an operation associated with each of the following items, based on a check message transmitted from the user terminals 220 and 230.

1) When the first data is the latest data as compared to the third data, the cloud data system 100 transmits the first data to the user terminals 220 and 230, as opposed to data information associated with the first data. In this instance, the cloud data system 100 requests update of the third data with the transmitted first data.

2) When the first data is not the latest data as compared to the third data, the user terminals 210 through 230 do not take any action. The data synchronization is terminated at the present step.

Here, referring to the item 2), the cloud data system 100 according to an embodiment of the present disclosure does not proceed with any further operation when the first data is not the latest data as compared to the third data, which draws one of the important features of the present disclosure.

3) Comparison between the first data and the third data is not executed by the cloud data system 100 according to an embodiment of the present disclosure. The cloud data system 100 is not called for an unnecessary process operation.

4) The cloud data system 100 exchanges only data information and a check message, with the user terminals 210 through 230, and data itself is not transferred.

5) When updating the third data with the first data is not needed as a result of the comparison between the first data and the third data, the cloud data system 100 according to an embodiment of the present disclosure converts a mode to a standby mode. This may generate little network traffic when compared to the conventional data synchronization method which executes synchronization by periodically exchanging data between a server and a client.

Desirably, the cloud data system 100 according to an embodiment of the present disclosure includes a data information extracting module 110, a check message processing module 120, a synchronization module 130, and the server tree DB 140.

The data information extracting module 110 is configured to inquire of the server tree DB 140 when data is uploaded from the user terminal 210, so as to extract data information of the stored second data corresponding to the data information of the uploaded first data, and provides the check message processing module 120 with the extracted second data information.

The check message processing module 120 is configured to compare the data information of the first data uploaded from the user terminal 210 and the data information of the second data that the data information extracting module 110 is configured to extract from the server tree DB 140. In this instance, the check message processing module 120 is configured to determine whether the first data and the second data are identical based on data titles and data sizes of the first data and the second data. The check message processing module 120 is configured to compare between the first data and the second data, and determines which of the data is the latest data.

When it is determined that the data are identical and the first data is the latest data, the check message processing module 120 is configured to transmit the data information of the first data to the user terminals 220 and 230, and in this instance, requests comparison with data information stored in the user terminals 220 and 230. In this instance, the check message processing module 120 is configured to transmit, to the user terminals 220 and 230, a data update request message including the data information of the first data and a command that requests latest data check.

When the user terminals 220 and 230 receive the data update request message, the user terminals 220 and 230 inquire data (third data) that matches the data included in the data update request message among the data stored in the user terminals 220 and 230, based on the data information included in the data update request message, and compares the data information of the third data and the data information of the first data and determines which of the data information is the latest data.

That is, according to an embodiment of the present disclosure, a subject that determines which of the data information is the latest data information using the first data information and the third data information, is the user terminal 220 and 230, as opposed to the cloud data system 100, which is one of the important features of the present disclosure.

According to the conventional file synchronization method or system, a server is a subject and determines which of data stored in a client and data stored in the server is the latest data. However, according to an embodiment of the present disclosure, in the cloud data system 100, the subject of the determination is the user terminal 220 and 230.

The cloud data system 100 and the user terminals 220 and 230 may not continuously maintain a session for determining an equality between data, and may not execute network communication for determining the latest data.

In addition, when the cloud data system 100 is informed that the first data is not the latest data as compared to the third data through the check message, the cloud data system 100 does not proceed with a further synchronization operation. This will be described with reference to FIG. 4.

FIG. 4 illustrates an operation state of the cloud data system 100 in a case in which the content included in the check message indicates that the first data is not the latest data as compared to the third data. The cloud data system 100 maintains a standby mode during a time when the first data is not the latest data as compared to the third data and the user terminals 210 through 230 do not upload data.

Conversely, the conventional file synchronization method or system periodically determines a priority of data between a server and a client although data is not uploaded from a user terminal.

Alternatively, when data is uploaded by the client, the server and the client open a session and exchange a packet, so that each entity compares and determines which of data is the latest data. In comparison with the conventional system, the cloud data system 100 according to an embodiment of the present disclosure executes a simple synchronization according to the following each item, as illustrated in FIG. 4.

6) The cloud data system 100->user terminals 220 and 230: transmit data update request message

7) User terminals 220 and 230->the cloud data system 100: check message

When the content of the check message provided from the user terminals 220 and 230 to the cloud data system 100 describes that the first data is not the latest data as compared to the third data, the cloud data system 100 according to an embodiment of the present disclosure enters into a standby mode as illustrated in FIG. 4, and thus, may not generate any network traffic.

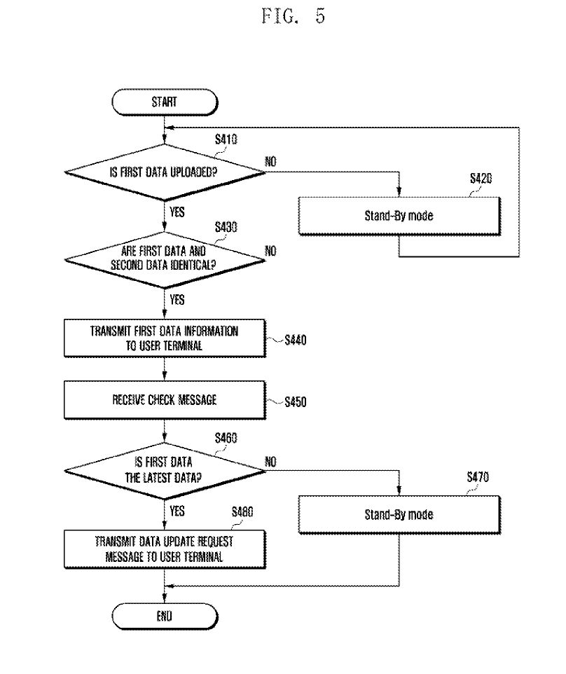

FIG. 5 is a conceptual diagram of a synchronization method of a cloud data system according to an embodiment of the present disclosure.

Referring to FIG. 5, the cloud data system 100 determines whether a request for uploading to the database 300 is generated in operation S410, maintains a standby mode in operation S420 when a request for uploading a first file to the database 300 is not generated, and determines an equality between first data and second data that is stored in advance in the database 300 in association with the first data in operation S430 when the request for uploading of the first file is generated. The determination associated with the equality is made based on a data title and a file size. When it is determined that the first data and the second data are identical, the cloud data system 100 determines which of the first data and the second data is the latest data. A criterion for determining the latest data is one of generation time information or modification time information of the first data and the second data, and data having the latest time information among the time information is determined to be the latest data.

Subsequently, the cloud data system 100 transmits first data information to a user terminal in operation S440, and receives a check message from the user terminal 220 and 230 in operation S450. In this instance, the user terminal 220 and 230 may include third data corresponding to the first data.

That is, the first data, the second data, and the third data are identical data, but the first data indicates data of which uploading to the cloud data system 100 is requested by the user terminal 210.

The second data is data that is included in the database 300 that is configured to be integrated with the cloud data system 100 or is separately configured.

The third data is different in that the data is included in the user terminal 220 and 230. The first data, the second data, and the third data are classified based on a subject (the user terminal 210, the cloud data system 100, and the user terminals 220 and 230) that stores the corresponding data, and correspond to the identical data. However, the first data, the second data, and the third data have a difference in time information. That is, it should be construed that the classification of the data is for distinguishing which of the data is the latest data.

Here, the check message includes a data title, a data size, and an identifier indicating which of the first data and the third data is the latest data.

Subsequently, the cloud data system 100 determines which of the first data and the third data is the latest data based on the check message in operation 5460.

Here, when the first data is the latest data as compared to the third data, that is, when the first data uploaded from the terminal 210 to the database 300 is the latest data, the cloud data system 100 transmits a data update request message to other user terminals 220 and 230 excluding the user terminal 210 that uploads the first data in operation 5470. Conversely, when the first data is not the latest data as compared to the third data, the cloud data system 100 does not proceed with further data synchronization, and enters into a standby mode in operation 5480.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A synchronizing method of a cloud data system that is connected, over a network, to a first terminal and a second terminal, which correspond to an identical account, the method comprising:
providing the second terminal with data information associated with data when the data is uploaded from the first terminal, and requesting and obtaining a check message for determining whether the data is the latest data;
terminating a data synchronization operation when it is determined that the data is not the latest data based on the check message of the second terminal; and
transmitting the data to the second terminal so as to request execution of a synchronization operation on the data when it is determined that the data is the latest data based on the check message of the second terminal.

2. The method of claim 1, wherein the data information includes at least one of a title of the data, a data generation date, and a data update date.

3. The method of claim 1, wherein the first terminal and the second terminal respectively include a first local Database (DB) and a second local DB, which include data information of internal data.

4. The method of claim 3, wherein the second terminal determines which of data associated with the data information and data stored in the second terminal is the latest data, based on the second local DB.

5. A cloud data system that is connected, over a network, to a first terminal and a second terminal, which correspond to an identical account, the cloud data system comprising:
a server tree DataBase (DB) configured to store stored data information associated with stored data of a data DB;
a check message processing module configured to determine, when the data is uploaded from the first terminal, an equality based on the stored data information and data information associated with data, and configured to transmit, when the equality is determined, the data information to the second terminal and to request a check message for determining whether the data is the latest data; and
a synchronization module configured to terminate a data synchronization operation when it is determined that the data is not the latest data based on the check message, and to proceed with a synchronization operation on the data with respect to the first terminal and the second terminal only when it is determined that the data is the latest data.

6. The cloud data system of claim 5, wherein the equality is an equality of at least one of a data generation date and a data update date between the data and the stored data.

7. The cloud data system of claim 5, wherein the first terminal and the second terminal are respectively configured to include a first local DB and a second local DB, which store the data information associated with internal data; and
the second terminal is configured to determine which of data associated with the data information and the data stored in the second terminal is the latest data, based on the second local DB.
